(19) United States
(12) Patent Application Publication
(10) Pub. No.: US 2012/0063793 A1
(43) Pub. Date: Mar. 15, 2012

(54) IMAGE FORMING APPARATUS INCLUDING CLEANING BLADE

(75) Inventors: Yasuji Watanabe, Toyokawa-shi (JP); Satoshi Hasegawa, Toyokawa-shi (JP)

(73) Assignee: Konica Minolta Business Technologies, Inc., Tokyo (JP)

(21) Appl. No.: 13/225,068

(22) Filed: Sep. 2, 2011

(30) Foreign Application Priority Data
Sep. 14, 2010 (JP) 2010-205947

(51) Int. Cl. G03G 21/00

(52) U.S. Cl. 399/34

(57) ABSTRACT

An image forming apparatus includes photoconductors capable of carrying toner images of yellow (Y), magenta (M), cyan (C), and black (K), developing rollers capable of developing toner images of Y, M, C, and K, and a blade for removing toner adhering to each of the developing rollers. The photoconductors are driven in synchronization with each other when at least one of the developing rollers develops a toner image. When a print job of a monochrome image is accepted and if there is a likelihood of damage to the blade, at least one of the developing rollers adheres toner to at least one of the driven photoconductors during execution of the print job.

This application is based on Japanese Patent Application No. 2010-205947 filed with the Japan Patent Office on Sep. 14, 2010, the entire content of which is hereby incorporated by reference.

### BACKGROUND OF THE INVENTION

1. Field of the Invention

The present invention relates to an image forming apparatus, a method of controlling the image forming apparatus, and a recording medium storing a control program for the image forming apparatus. More particularly, the present invention relates to an image forming apparatus, such as an electrophotographic copier or an electrophotographic printer, having image carrying units of yellow (hereinafter also referred to as Y), magenta (hereinafter also referred to as M), cyan (hereinafter also referred to as C), and black (hereinafter also referred to as K) which are driven in synchronization with each other, a method of controlling the image forming apparatus, and a recording medium storing a control program for the image forming apparatus.

2. Description of the Related Art

Electrophotographic image forming apparatuses include, for example, MFPs (Multi Function Peripherals) having a scanner function, a facsimile function, a copy function, a printer function, a data communication function, and a server function, facsimile machines, copiers, and printers.

In a tandem-type image forming apparatus, in particular, image forming units for forming Y, M, C, and K toner images are arranged in a direction in which an intermediate transfer belt moves. The Y, M, C, and K image forming units form electrostatic latent images on photoconductors by exposing the charged photoconductors, form Y, M, C, and K toner images on the photoconductors by supplying toner from development units (develop the electrostatic latent images), and then successively superimpose the Y, M, C, and K toner images on the intermediate transfer belt by transferring the toner images from the photoconductors onto the intermediate transfer belt. The image forming apparatus transfers the toner image formed by superimposing Y, M, C, and K from the intermediate transfer belt onto paper and fixes the transferred toner image on the paper thereby forming an image on paper. The toner left on the photoconductors after transfer is collected into a toner waste box by blades (cleaning blades) on the photoconductors.

Document 1 below discloses a technique concerning formation of a monochrome image by an image forming system. According to Document 1 below, when an instruction to form a monochrome image is given, if the remaining amount of black (K) toner is zero, a monochrome image is formed with composite black obtained by superimposing Y, M, and C toners.

### [Document 1] Japanese Patent Laid-Open Publication No. 2004-237657

In an image forming apparatus, Y, M, C, and K photoconductors are often driven in synchronization with each other by a single motor for the purpose of simplification of the apparatus configuration and cost reduction. However, such an image forming apparatus is less durable. This problem will be described in detail below.

FIG. 12 schematically shows a state of photoconductors in printing in a monochrome mode (printing a monochrome image) in an image forming apparatus of the related art.

Referring to FIG. 12, when the image forming apparatus does printing in the monochrome mode, Y, M, C, and K photoconductors 103a to 103d are all driven by a motor in the direction shown by the arrow A2 in FIG. 12 while only a K developing roller 104d is rotatably driven in the direction shown by the arrow A3 in FIG. 12 to develop a K toner image on photoconductor 103d. Y, M, and C photoconductors 103a to 103c are not supplied with toner, in other words, they are rotated while Y, M, C developing rollers 104a to 104c are not being driven. Then, the K toner image developed by rotation of photoconductor 103d is transferred onto an intermediate transfer belt 113 rotating in the direction shown by the arrow A1 in FIG. 12 to form a toner image K1, which is transferred onto paper S. Toner K2 left on photoconductor 103d after the transfer is collected by a blade 107d.

Here, photoconductors 103a to 103d are provided with blades 107a to 107d, respectively, for collecting toner left on photoconductors 103a to 103d after transfer. An increase of friction between photoconductors 103a to 103d and blades 107a to 107d is prevented by toner that adheres to blades 107a to 107d when the toner is collected. However, when only the monochrome mode keeps on without printing in the color mode (printing color images), photoconductors 103a to 103c are kept rotating without developing rollers 104a to 104c being driven. This increases the friction between photoconductors 103a to 103c and blades 107a to 107c and increases the load on blades 107a to 107c. As a result, blades 107a to 107c may be damaged. The blades are easily damaged, in particular, when about 100 sheets of monochrome images are printed, for example.

Then, in order to prevent damage to blades 107a to 107c, it is proposed to periodically stop printing and to apply toner to blades 107a to 107c by giving a patch to Y, M, and C photoconductors 103a to 103c. Here, “to give a patch” means supplying a prescribed amount of toner from a development unit to a photoconductor.

FIG. 13 schematically shows a state of photoconductors in the case where a patch is given to the photoconductors.

Referring to FIG. 13, when printing is periodically stopped and toner is applied to blades 107a to 107d by giving a patch to Y, M, C, and K photoconductors 103a to 103d, Y, M, C, and K toner images Y1, M1, C1, and K1 are transferred from photoconductors 103a to 103d onto intermediate transfer belt 113. The toner image transferred onto intermediate transfer belt 113 is collected by a not-shown cleaning blade for intermediate transfer belt 113. On the other hand, Y, M, C, and K toners Y2, M2, C2, and K2 left on photoconductors 103a to 103d after transfer are collected by blades 107a to 107d and then adhere to blades 107a to 107d while being collected. A patch may be given in a state in which no toner image is transferred onto intermediate transfer belt 113 (a state in which primary transfer from the photoconductors is off).

However, in the method shown in FIG. 13, it is necessary to interrupt the accepted print job to give a patch, resulting in the reduced productivity and the increased in toner consumption.

The technique in Document 1 merely produces K using Y, M, and C toners when the remaining amount of K toner is zero, and cannot solve the problem of poor durability.

### SUMMARY OF THE INVENTION

The present invention is made to solve the aforementioned problem and aims to provide an image forming apparatus with improved durability, a method of controlling the image forming apparatus, and a control program for the image forming apparatus.

In accordance with an aspect of the present invention, an image forming apparatus includes: an accepting unit for accepting a print job; a yellow image carrying unit, a magenta image carrying unit, a cyan image carrying unit, and a black image carrying unit being capable of carrying toner images of yellow, magenta, cyan, and black, respectively; a yellow development unit, a magenta development unit, a cyan development unit, and a black development unit being capable of developing toner images of yellow, magenta, cyan, and black, respectively, on the yellow image carrying unit, the magenta image carrying unit, the cyan image carrying unit, and the black image carrying unit, respectively; a cleaning blade for removing toner adhering to at least one of the yellow image carrying unit, the magenta image carrying unit, and the cyan image carrying unit; and a determination unit for determining a likelihood of damage to the cleaning blade. The yellow image carrying unit, the magenta image carrying unit, the cyan image carrying unit, and the black image carrying unit are driven in synchronization with each other when at least one of the yellow development unit, the magenta development unit, the cyan development unit, and the black development unit develops a toner image. When the accepting unit accepts a print job of a monochrome image and if the determination unit determines that there is a likelihood of damage to the cleaning blade, at least one of the yellow development unit, the magenta development unit, and the cyan development unit adheres toner to at least one of the driven yellow image carrying unit, magenta image carrying unit, and cyan image carrying unit during execution of the print job.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view schematically showing a hardware configuration of an image forming apparatus in an embodiment of the present invention.

FIG. 2 is a block diagram showing a configuration of the image forming apparatus in FIG. 1.

FIG. 3 is a diagram for illustrating a first method of preventing blade damage in the embodiment of the invention.

FIG. 4 schematically shows a partial monochrome image printed on paper S as a result of execution of the first method of preventing blade damage in the embodiment of the invention.

FIG. 5 is a diagram for illustrating a second method of preventing blade damage in the embodiment of the invention.

FIG. 6 is a diagram for illustrating a third method of preventing blade damage in the embodiment of the invention.

FIG. 7 is a flowchart A showing a process of preventing damage to blades 7a to 7c, which is executed by a control unit 60 of image forming apparatus 1.

FIG. 8 shows the relation between control unit 60 and a main motor 41 (motor interface).

FIG. 9 is a flowchart B showing a process of preventing damage to blades 7a to 7c, which is executed by control unit 60 of image forming apparatus 1.

FIG. 10 shows a subroutine of a printing and blade damage preventing process in FIG. 7 and FIG. 9 in details.

FIG. 11 is a flowchart C showing a process of preventing damage to blades 7a to 7c, which is executed by control unit 60 of image forming apparatus 1.

FIG. 12 schematically shows a state of photoconductors in printing in a monochrome mode (printing a monochrome image) in an image forming apparatus of the related art.

FIG. 13 schematically shows a state of photoconductors in a case where a patch is given to photoconductors.

### DESCRIPTION OF THE PREFERRED EMBODIMENTS

In the following, an embodiment of the present invention will be described based on the figures.

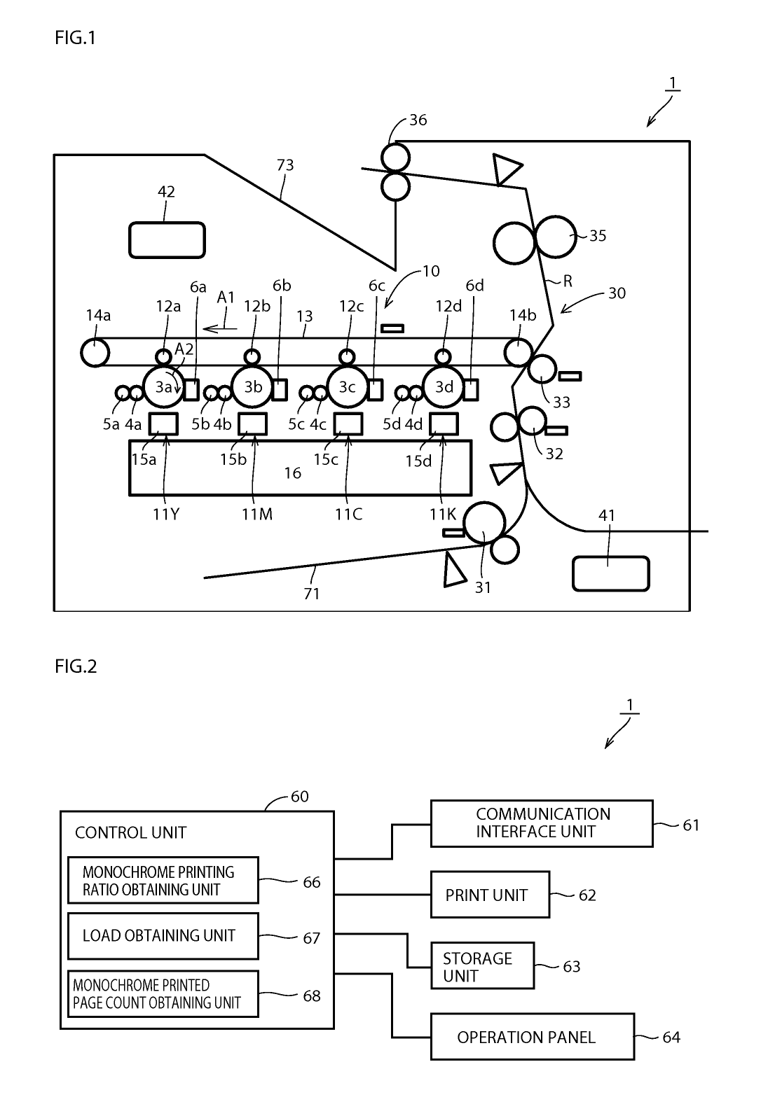

Referring to FIG. 1, an image forming apparatus 1 in the present embodiment is, for example, a color printer, and mainly includes an image creating unit 10 and a conveyance unit 30.

Image creating unit 10 combines four color images of yellow (Y), magenta (M), cyan (C), and black (K) in a tandem manner as necessary to form a color image on paper (recording medium). Image creating unit 10 includes image creating units 11Y, 11M, 11C, and 11K (which may be hereinafter collectively called image creating units 11) corresponding to colors Y, M, C, K, respectively, primary transfer rollers 12a to 12d (which may be hereinafter collectively called primary transfer rollers 12) corresponding to image creating units 11Y, 11M, 11C, and 11K, respectively, an intermediate transfer belt 13, a printer head (PH) 16, and exposure devices 15a to 15d (which may be hereinafter collectively called exposure devices 15) corresponding to image creating units 11Y, 11M, 11C, and 11K, respectively.

Image creating units 11 are arranged immediately below intermediate transfer belt 13. Image creating units 11 are disposed to be opposed to primary transfer rollers 12 corresponding to the respective image creating units 11 with intermediate transfer belt 13 interposed therebetween. Intermediate transfer belt 13 is annularly shaped and runs between two rollers 14a and 14b. Intermediate transfer belt 13 is rotatably driven in the direction shown by the arrow A1 in FIG. 1 by the rotation of rollers 14a and 14b. A secondary transfer roller 33 is disposed to be opposed to roller 14b with intermediate transfer belt 13 interposed therebetween. The distance between intermediate transfer belt 13 and secondary transfer roller 33 is adjusted by a press-contact separating mechanism (not shown). Print head 16 and exposure devices 15 are disposed such that laser beams from print head 16 can scan photoconductors 3a to 3d through exposure devices 15.

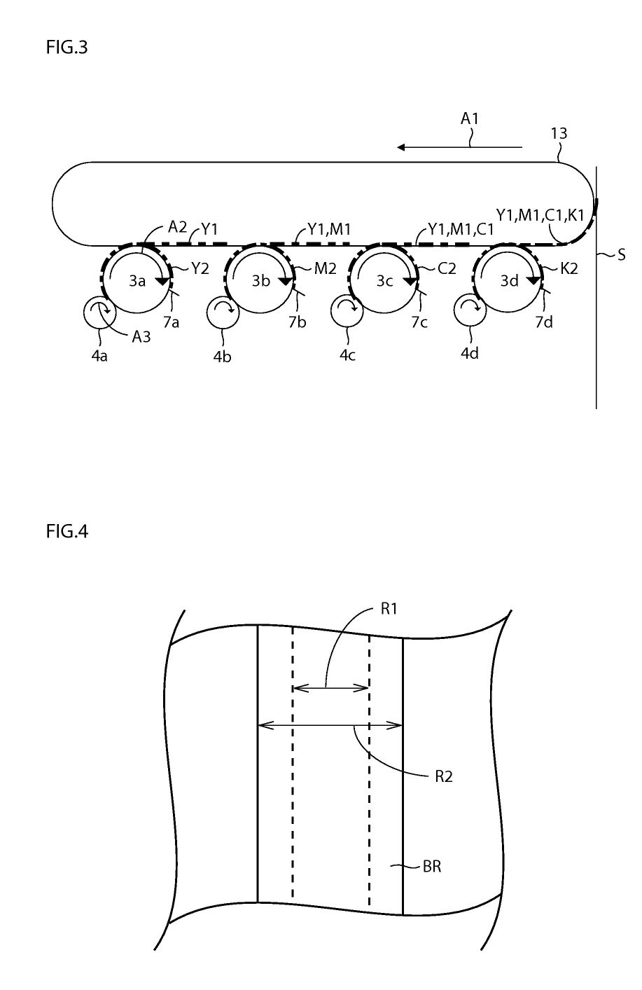

Of image creating units 11Y, 11M, 11C, and 11K, here, image creating unit 11Y for forming a yellow toner image is taken as an example. Image creating unit 11Y includes a photoconductor 3a (an exemplary yellow image carrying unit), a developing roller 4a (an exemplary yellow development unit), a supply roller 5a, a charger 6a, and a blade 7a (an exemplary cleaning blade, see FIG. 3). Photoconductor 3a is disposed to be opposed to primary transfer roller 12a corresponding to image creating unit 11Y. Developing roller 4a, charger 6a, and blade 7a are disposed on the outer circumference of photoconductor 3a. Supply roller 5a is disposed in proximity to developing roller 4a. Blade 7a removes toner left on photoconductor 3a after transfer and collects the removed toner into a toner waste box.

Similar to image creating unit 11Y, image creating unit 11M for forming a magenta toner image includes a photoconductor 3b (an exemplary magenta image carrying unit), a developing roller 4b (an exemplary magenta development unit), a supply roller 5b, a charger 6b, and a blade 7b (FIG. 3). Image creating unit 11C for forming a cyan toner image includes a photoconductor 3c (an exemplary cyan image carrying unit), a developing roller 4c (an exemplary cyan development unit), a supply roller 5c, a charger 6c, and a blade 7c (FIG. 3). Image creating unit 11K for forming a black toner image includes a photoconductor 3d (an exemplary black image carrying unit), a developing roller 4d (an exemplary black development unit), a supply roller 5d, a charger 6d, and a blade 7d (FIG. 3). Image creating units 11M, 11C, and 11K each have a configuration similar to the configuration of image creating unit 11Y, and a description thereof will not be repeated here.

Conveyance unit 30 feeds paper stored in a paper-feed cassette 71 sheet by sheet and conveys the paper to an output tray 73 along a conveyance path R. Conveyance unit 30 includes a paper-feed roller 31, a timing roller 32, secondary transfer roller 33, a fixing roller 35, and a discharge roller 36. Paper-feed roller 31, timing roller 32, secondary transfer roller 33, fixing roller 35, and discharge roller 36 are arranged in this order from the upstream side (the lower side in FIG. 1) to the downstream side (the upper side in FIG. 1) in the conveyance direction along conveyance path R.

Image forming apparatus 1 further includes a main motor 41 and a development motor 42. Main motor 41 and development motor 42 are, for example, brushless DC motors. Photoconductors 3, rollers 14a and 14b, paper-feed roller 31, timing roller 32, secondary transfer roller 33, fixing roller 35, and discharge roller 36 are driven by the rotation of main motor 41. Therefore, when at least one of developing rollers 4a to 4d forms a toner image, photoconductors 3a to 3d are driven in synchronization with each other. Developing rollers 4 and supply rollers 5 are driven by the rotation of development motor 42. For example, when printing is done in the color mode, for example, development motor 42 is rotated in a forward direction (forward rotation) to drive all developing rollers 4a to 4d and supply rollers 5a to 5d. On the other hand, when printing is done in the monochrome mode, development motor 42 is rotated in a reverse direction (reverse rotation) to drive only K developing roller 4d and supply roller 5d while Y, M, and C developing rollers 4a to 4c and supply roller 5a to 5c are standing still. In this manner, the switching between the forward rotation and the reverse rotation of development motor 42 allows switching between the color mode and the monochrome mode. This configuration can be implemented, for example, by using a planetary gear train.

An operation of the image forming apparatus in printing a color image on paper will now be described.

In image creating unit 11Y, a toner image is formed on photoconductor 3a in the following manner. Photoconductor 3a rotates in the direction shown by the arrow A2 in FIG. 1. After blade 7a removes toner left on photoconductor 3a, charger 6a supplies electric charges onto photoconductor 3a to uniformly charge photoconductor 3a. Print head 16 scans laser light on the uniformly charged photoconductor 3a through exposure device 15a corresponding to image creating unit 11Y, based on image data of the accepted print job. A static latent image is thus formed on photoconductor 3a. Supply roller 5a supplies toner to developing roller 4a, and developing roller 4a in turn supplies toner onto photoconductor 3a to develop the static latent image. A Y toner image is thus formed on photoconductor 3a. Image creating units 11M, 11C, and 11K form M, C, and K toner images on photoconductors 3b to 3d, respectively, in a similar manner.

In the specification of this application, “to develop” means that supplying toner to a static latent image causes a toner image to appear. When a toner image is developed on a photoconductor, toner adheres on the photoconductor, as a matter of course.

The Y, M, C, and K toner images carried on photoconductors 3a to 3d, respectively, are attracted to primary transfer rollers 12a to 12d supplied with voltage and are successively transferred onto intermediate transfer belt 13 (primary transfer). At this time, the transfer operations of photoconductors 3a to 3d are executed at timings shifted such that the toner images are transferred so as to be superimposed on one another at the same location of the moving intermediate transfer belt 13. The toner image formed on intermediate transfer belt 13 is conveyed to secondary transfer roller 33. Secondary transfer roller 33 is pressed in contact with intermediate transfer belt 13 before the toner image formed on intermediate transfer belt 13 arrives at secondary transfer roller 33.

On the other hand, paper stored in paper-feed cassette 71 is fed to conveyance path R by paper-feed roller 31 and is conveyed to timing roller 32. The paper conveyed to the timing roller 32 is temporarily stopped by liming roller 32 and is then conveyed to secondary transfer roller 33 at a timing when the toner image formed on intermediate transfer belt 13 arrives at secondary transfer roller 33. The toner image formed on intermediate transfer belt 13 is transferred by secondary transfer roller 33 onto the paper conveyed to secondary transfer roller 33 (secondary transfer). The paper having the toner image transferred thereon is conveyed to fixing roller 35, so that the toner image is fixed by fixing roller 35. After fixing, the paper is discharged to output tray 73 by discharge roller 36.

FIG. 2 is a block diagram showing a configuration of the image forming apparatus in FIG. 1.

Referring to FIG. 2, image forming apparatus 1 includes a control unit 60, a communication interface unit 61, a print unit 62, a storage unit 63, and an operation panel 64. Communication interface unit 61, print unit 62, storage unit 63, and operation panel 64 are connected to control unit 60.

Control unit 60 is a CPU and controls various operations of image forming apparatus 1 by executing a control program stored in storage unit 63. Control unit 60 executes a prescribed control program, for example, in response to an operation signal sent from operation panel 64 or an operation command sent from a client PC. A prescribed operation of image forming apparatus 1 is thus performed in accordance with an operation input by the user to operation panel 64 or an instruction from a client PC.

Communication interface unit 61 is formed of a combination of, for example, a hardware unit such as an NIC (Network Interface Card) and a software unit for communication via a prescribed communication protocol. Communication interface unit 61 connects image forming apparatus 1 to, for example, a network such as a LAN. This allows image forming apparatus 1 to communicate with an external device such as a client PC connected to a network and to accept a print job from a client PC. Communication interface unit 61 may be configured to be able to wirelessly communicate with an external network.

Print unit 62 feeds paper from paper-feed cassette 71 and conveys the paper inside image forming apparatus 1, under the control by control unit 60. Print unit 62 forms an image on the conveyed paper by electrophotography and discharges the paper to output tray 73. Print unit 62 can print image data (raster data) expanded in a printable format, based on data in a print data format sent from the client PC connected to image forming apparatus 1 or data in a print data format stored in an HDD of storage unit 63. The expansion of data into printable format is performed, for example, in control unit 60.

Storage unit 63 is used to store data to be used for operation of image forming apparatus 1, including data necessary for control unit 60 to execute a control program, a variety of control programs, and data for function settings. Storage unit 63 also stores the ratio of monochrome printing in the past printing. Storage unit 63 further stores the number of pages of monochrome images that have been printed by image forming apparatus 1 in the past. Storage unit 63 further stores a variety of reference values to be used to determine the likelihood of damage to the blades. Control unit 60 performs prescribed processing for reading data in storage unit 63 and writing data into storage unit 63.

Control unit 60 includes a monochrome printing ratio obtaining unit 66, a load obtaining unit 67, and a monochrome printed page count obtaining unit 68. Monochrome printing ratio obtaining unit 66 obtains from storage unit 63 the ratio of monochrome printing in the past printing in image forming apparatus 1. Load obtaining unit 67 obtains a load on main motor 41 driving photoconductors 3a to 3d in synchronization with each other. Monochrome printed page count obtaining unit 68 obtains the number of pages of monochrome images printed in image forming apparatus 1.

### [Methods of Preventing Blade Damage]

In image forming apparatus 1 in the present embodiment, at least one of the following three methods is used to prevent damage to the blades when there is a likelihood of damage to blades 7a to 7c.

### (1) First Method of Preventing Blade Damage

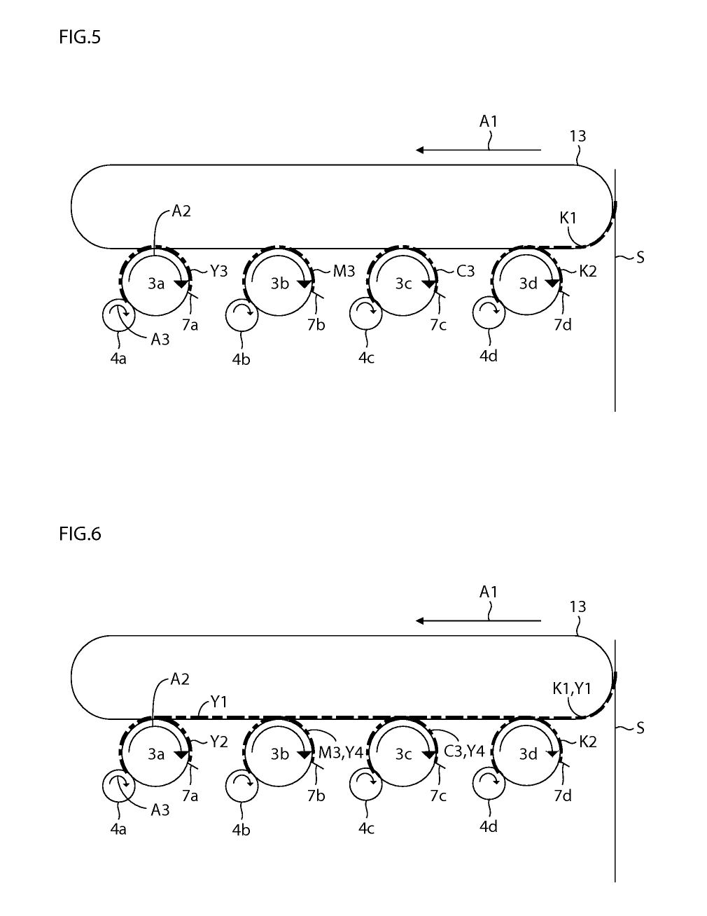

FIG. 3 is a diagram for illustrating a first method of preventing blade damage in the embodiment of the invention. It is noted that FIG. 3, FIG. 5, and FIG. 6 only show photoconductors 3a to 3d, developing rollers 4a to 4d, blades 7a to 7d, intermediate transfer belt 13, and paper S onto which a toner image is transferred, for convenience of explanation.

Referring to FIG. 3, in the first method, when a toner image for a monochrome image to be printed is developed, Y, M, C, and K developing rollers 4a to 4d are rotatably driven in the direction shown by the arrow A3 in FIG. 3 while Y, M, C, and K photoconductors 3a to 3d are rotatably driven in the direction shown by the arrow A2 in FIG. 3. Then, Y, M, C, and K developing rollers 4a to 4d develop toner images on photoconductors 3a to 3d, respectively, at respective prescribed timings. The toner images carried on photoconductors 3a to 3d are transferred onto intermediate transfer belt 13 rotated in the direction shown by the arrow A1 in FIG. 3 such that Y toner image Y1, M toner image M1, C toner image C1, and K toner image K1 are superimposed on each other in this order. It is noted that FIG. 3 shows a toner image immediately after the transfer of toner image Y1, a toner image immediately after the transfer of toner image M1, and a toner image immediately after the transfer of toner image C1, in addition to the toner image formed of the superimposed toner images Y1, M1, C1, and K1, for convenience of illustration.

Y, M, C, and K toners (toner residues) Y2, M2, C2, and K2 left on photoconductors 3a to 3d after transfer are removed by blades 7a to 7d, respectively, and collected into a not-shown waste box. During toner collection, toner adheres to blades 7a to 7d. As a result, the toner adhering to blades 7a to 7c prevents an increase of friction between photoconductors 3a to 3c and blades 7a to 7c, thereby preventing damage to blades 7a to 7c.

On the other hand, the superimposed toner image on intermediate transfer belt 13 is transferred onto paper S by secondary transfer roller 33 (FIG. 1). As a result, a toner image for a monochrome image to be printed on paper S is created in composite black obtained by mixing Y, M, C, and K. In other words, in the first method, developing rollers 4a to 4c are operated at prescribed timings during printing in the monochrome mode, so that a K toner image is formed by mixing Y, M, and C toners and then superimposed on a toner image created from K, resulting in a monochrome image.

Composite black is preferably formed by superimposing K on Y, M, and C although it may be formed of at least three colors Y, M, and C. The quality of K can be improved when composite black is formed of four color toners Y, M, C, and K.

FIG. 4 schematically shows a partial monochrome image printed on paper S as a result of execution of the first method of preventing blade damage in the embodiment of the invention.

Referring to FIG. 4, a monochrome image BR includes an area R1 in which Y, M, and C toners are transferred and an area R2 in which K toner is transferred. The monochrome image in composite black formed of Y, M, and C toners is formed by mixing multiple toners and is thus susceptible to degradation in image quality such as color displacement or too thick lines, as compared with a monochrome image formed only with K toner. In order to prevent such degradation in image quality, monochrome image BR printed is preferably formed such that a black area formed of only K toner (that part of area R2 which does not overlap with area R1) surrounds a composite black area (area R1) formed of Y, M, and C toners. In this case, the thickness of the line in area R1 in which Y, M, and C toners are transferred is smaller than the thickness of the line in area R2 in which K toner is transferred. Areas R1 and R2 can be set by the shapes of toner images developed by developing rollers 4a to 4d.

When a monochrome image in composite black is formed, it is preferable to set the maximum amount of superimposed toners in order to prevent color displacement or poor fixing. In this case, the amount of toner of each color can be set uniformly, based on the maximum amount of superimposed toners. For example, when the maximum amount of superimposed toners is set to be 200% of the reference value of the toner amount, an area in which toners are superimposed at the maximum amount may be formed using Y, M, C, K toners each in the amount of 50% of the reference value.

### (2) Second Method of Preventing Blade Damage

FIG. 5 is a diagram for illustrating a second method of preventing blade damage in the embodiment of the invention.

Referring to FIG. 5, in the second method, when a toner image for a monochrome image to be printed is developed, Y, M, C, and K developing rollers 4a to 4d are rotatably driven in the direction shown by the arrow A3 in FIG. 5 while Y, M, C, and K photoconductors 3a to 3d are rotatably driven in the direction shown by the arrow A2 in FIG. 5. Then, only K developing roller 4d develops a K toner image on photoconductor 3d, whereas Y, M, and C developing rollers 4a to 4c are rotatably driven without developing toner images. The developing roller can be prevented from developing a toner image, for example, by preventing the photoconductor from being exposed or by preventing voltage necessary for development from being applied between the photoconductor and the developing roller.

For example, when development is not performed for a long time, toner that is too degraded to be charged adheres, though even a small amount, on Y, M, and C developing rollers 4a to 4c. When developing rollers 4a to 4c are rotated in this state, the rotation of developing rollers 4a to 4c causes the degraded toner to scatter and adhere onto photoconductors 3a to 3c even when photoconductors 3a to 3c are not being exposed. The toner adhering in this manner is called “fog tonner.”

Therefore, when developing rollers 4a to 4c are rotatably driven without developing, toners Y3, M3, and C3, which are fog toner, are produced on photoconductors 3a to 3c. Toners Y3, M3, and C3 produced on photoconductors 3a to 3c are collected by blades 7a to 7c and adhere to blades 7a to 7c while being collected. As a result, the toner adhering to blades 7a to 7c prevents an increase of friction between photoconductors 3a to 3c and blades 7a to 7c thereby preventing damage to blades 7a to 7c.

In order to prevent toners Y3, M3, and C3 adhering to photoconductors 3a to 3c from attaching to intermediate transfer belt 13, the primary transfer voltage to be applied to Y, M, and C primary transfer rollers 12a to 12c is turned off when Y, M, C, and K developing rollers 4a to 4d are rotatably driven.

On the other hand, the K toner image developed on photoconductor 3d is transferred onto intermediate transfer belt 13 rotated in the direction shown by the arrow A1 in FIG. 5, and the toner image transferred on intermediate transfer belt 13 is then transferred onto paper S by secondary transfer roller 33 (FIG. 1). As a result, the toner image for a monochrome image to be printed on paper S is created only with K toner image K1.

The second method of preventing blade damage has a smaller effect of preventing blade damage than the first method of preventing blade damage because toner residues resulting from development are not produced on photoconductors 3a to 3c and the amount of toner adhering to blades 7a to 7c is small. On the other hand, the toner consumption can be reduced as compared with the first method of preventing blade damage because fog toner is utilized to protect blades 7a to 7c.

### (3) Third Method of Preventing Blade Damage

FIG. 6 is a diagram for illustrating a third method of preventing blade damage in the embodiment of the invention.

Referring to FIG. 6, in the third method, when a toner image for a monochrome image to be printed is developed, Y, M, C, and K developing rollers 4a to 4d are rotatably driven in the direction shown by the arrow A3 in FIG. 6 while Y, M, C, and K photoconductors 3a to 3d are rotatably driven in the direction shown by the arrow A2 in FIG. 6. Then, Y and K developing rollers 4a and 4d develop toner images on photoconductors 3a and 3d, whereas M and C developing rollers 4b and 4c are rotatably driven without developing a toner image. Here, K developing roller 4d develops a toner image for the monochrome image to be printed, and Y developing roller 4a develops a toner image different from the monochrome image to be printed, for example, in a dotted area (having a fine dot pattern). The dotted area of Y printed on paper is too light to be noticed, and therefore, printing with Y scarcely reduces the image quality. Desirably, the area in which a Y dot pattern is formed extends over the entire monochrome image to be printed in order to attach Y toner as widely as possible in the width direction of blades 7a to 7c (the direction vertical to the plane of the drawing sheet of FIG. 6).

The Y toner image developed at photoconductor 3a is transferred onto intermediate transfer belt 13 (an exemplary transferred unit) rotated in the direction shown by the arrow A1 in FIG. 6. Part of toner that forms the Y toner image Y1 transferred on intermediate transfer belt 13 is reversely transferred onto M and C photoconductors 3b and 3c while moving on intermediate transfer belt 13 toward K photoconductor 3d. Accordingly, the reversely transferred Y toner Y4 adheres to M and C photoconductors 3b and 3c. Therefore, toner Y2, which is toner residue of Y after transfer, adheres to photoconductor 3a. Toner M3, which is fog toner of M, and the reversely transferred Y toner Y4 adhere to photoconductor 3b. Toner C3, which is fog toner of C, and the reversely transferred Y toner Y4 adhere to photoconductor 3c. These toners are collected by blades 7a to 7c and adhere to blades 7a to 7c while being collected. As a result, the toner adhering to blades 7a to 7c prevents an increase of friction between photoconductors 3a to 3c and blades 7a to 7c thereby preventing damage to blades 7a to 7c.

In a case where the operation of the primary transfer can switch between Y, M, C, and K, in order to prevent toners M3 and C3, which are fog toner adhering to photoconductors 3b and 3c, from attaching to intermediate transfer belt 13, it is preferable that the primary transfer voltage to be applied to Y primary transfer roller 12a is turned on whereas the primary transfer voltage to be applied to M and C primary transfer rollers 12b and 12c is turned off when Y, M, C, and K developing rollers 4a to 4d are rotatably driven.

On the other hand, Y toner image Y1 and K toner image K1 transferred onto intermediate transfer belt 13 are transferred onto paper S by secondary transfer roller 33 (FIG. 1). As a result, printed on paper S is a color image formed of a K image created from a K toner image and a Y image in a dot pattern created from a Y toner image.

The third method of preventing blade damage has a smaller effect of preventing blade damage than the first method of preventing blade damage since the toner residue resulting from development is not produced at photoconductors 3b and 3c and the amount of toner adhering to blades 7b and 7c is small. However, the effect of preventing blade damage is larger than the second method of preventing blade damage, because a large amount of toner residue adheres to blade 7a, and the fog toner as well as the reversely transferred toner adheres to blades 7b and 7c. On the other hand, although the toner consumption is higher than the second method of preventing blade damage because of the development at photoconductor 3a, the toner consumption is lower than the first method of preventing blade damage since development is not performed at M and C developing rollers 4b and 4c.

In the third method of preventing blade damage, fog toner may not adhere and only the reversely transferred Y toner may adhere to photoconductors 3b and 3c. In this case, the reversely transferred Y toner can be attached to blades 7b and 7c via photoconductors 3b and 3c, respectively.

### [Flowchart of Blade Damage Preventing Process]

In image forming apparatus 1 in the present embodiment, a blade damage preventing process is executed using at least one of the following three flowcharts.

### (1) Flowchart A of Damage Preventing Process

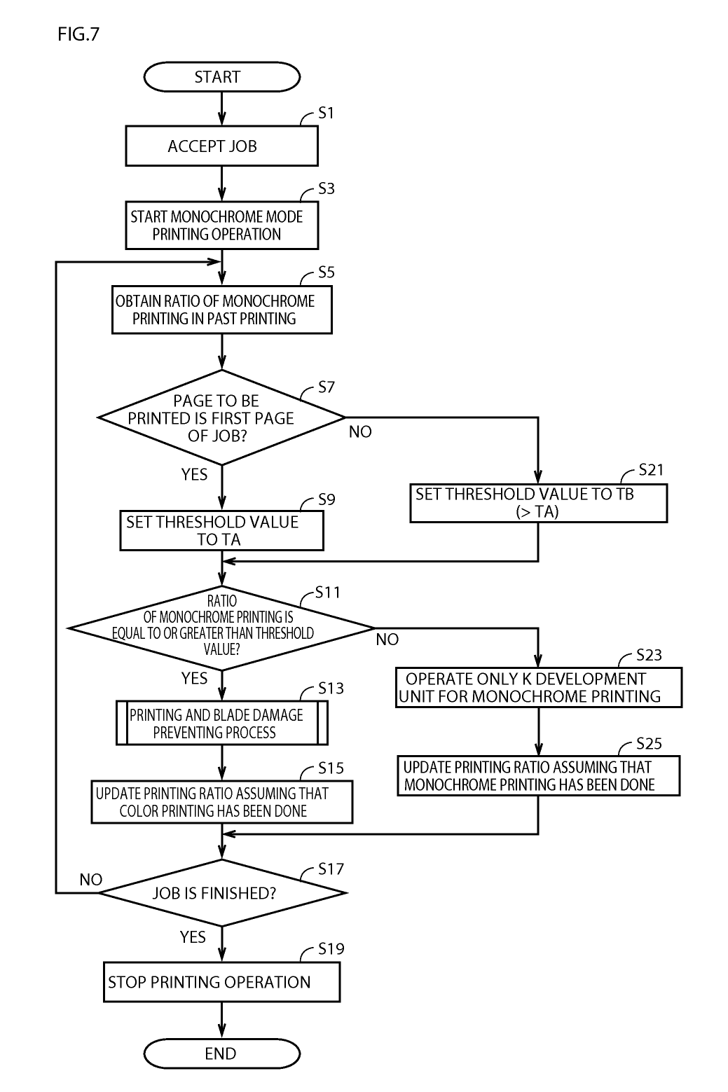

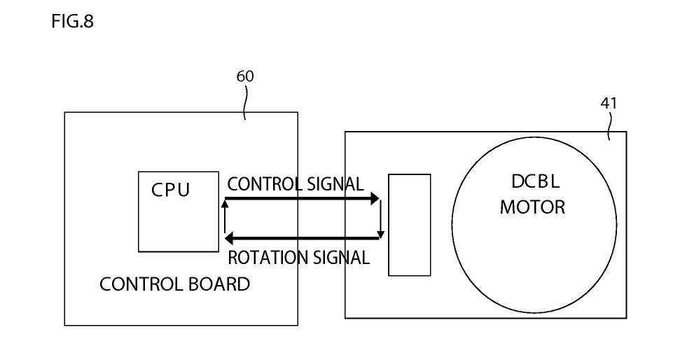

In a flowchart A of a damage preventing process, the likelihood of damage to blades 7a to 7c is determined based on the relation between the ratio of monochrome printing in the past printing in image forming apparatus 1 and a threshold value (reference value) of the ratio of monochrome printing. If there is a likelihood of damage to blades 7a to 7c, a damage preventing process is executed. FIG. 7 is a flowchart A showing a process of preventing damage to blades 7a to 7c, which is executed by control unit 60 of image forming apparatus 1.

Referring to FIG. 7, when image forming apparatus 1 accepts a print job for a monochrome image (S1), control unit 60 starts a printing operation in the monochrome mode by allowing main motor 41 to rotatably drive photoconductors 3a to 3d (S3). Then, control unit 60 obtains from storage unit 63 the ratio of monochrome printing in the past printing during the printing operation (S5). The ratio of monochrome printing in the past printing is the proportion of the number of pages of monochrome images to the total number of pages of color images and monochrome images printed in image forming apparatus 1. The ratio of monochrome printing may be, for example, the proportion of the number of pages of monochrome images in the latest printing history of a prescribed number of pages (for example, 100 pages).

Control unit 60 then determines whether the page to be printed from now on is the first page of the job (S7). If the page to be printed from now on is the first page of the job (YES in S7), control unit 60 sets the threshold value to a value TA (S9). If not (NO in S7), control unit 60 sets the threshold value to a value TB greater than the value TA (S21).

After setting the threshold value, control unit 60 determines whether the obtained ratio of monochrome printing is equal to or greater than the threshold value (S11). For example, when the latest printing history of 100 pages shows that the number of pages of monochrome images is 90 and the number of pages of color images is 10, the ratio of monochrome printing is 90%, which is determined to be greater than the threshold value where the threshold value of the printing ratio is 80%.

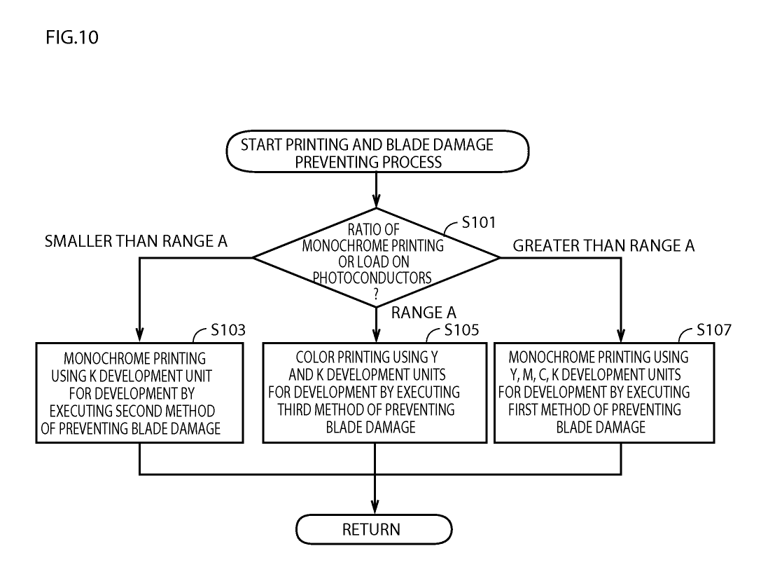

If the ratio of monochrome printing is equal to or greater than the threshold value in step S11 (YES in S11), it means that printing of monochrome images is frequent and there is a likelihood of damage to blades 7a to 7c. In this case, control unit 60 performs a blade damage preventing process together with printing (S13). The printing and blade damage preventing process will be described later using FIG. 10. After executing printing of one page and a blade damage preventing process, control unit 60 updates the ratio of monochrome printing stored in storage unit 63, assuming that printing of one page of a color image has been executed (S15). The process then proceeds to step S17.

If the ratio of monochrome printing is smaller than the threshold value in step S11 (NO in S11), it means that there is no likelihood of damage to blades 7a to 7c. In this case, control unit 60 drives only K developing roller 4d (K development unit) and executes printing of a monochrome image as usual, without performing a blade damage preventing process (S23). After execution of printing of one page, control unit 60 updates the ratio of monochrome printing stored in storage unit 63, assuming that printing of one page of a monochrome image has been executed (S25). The process then proceeds to step S17.

In step S17, control unit 60 determines whether printing of the job is completely finished (S17). If printing of the job is not finished (NO in S17), the process returns to step S5 and proceeds to printing of the next page. If printing of the job is completely finished (YES in S17), control unit 60 stops the printing operation (S19). The process then ends.

### (2) Flowchart B of Damage Preventing Process

In a flowchart B of a damage preventing process, the likelihood of damage to blades 7a to 7c is determined based on the relation between a value concerning load on Y, M, and C photoconductors 3a to 3c and a threshold value (reference value) for the load, and if there is a likelihood of damage to blades 7a to 7c, a damage preventing process is executed. The load on Y, M, and C photoconductors 3a to 3c is obtained, for example, from the load on main motor 41 driving Y, M, and C photoconductors 3a to 3c. FIG. 8 shows the relation between control unit 60 and main motor 41 (motor interface).

Referring to FIG. 8, the CPU of control unit 60 sends a control signal as a voltage (for example, 3V) to main motor 41. Receiving this voltage, main motor 41 rotates and sends back a rotation signal to control unit 60. When the magnitude of the load on main motor 41 is a normal value, main motor 41 sends back a rotation signal having a certain value (for example, 4000 revolutions). However, when the load on photoconductors 3a to 3c and main motor 41 increases, the rotation signal of main motor 41 has a value lower than the certain value (for example, 3800 revolutions). Therefore, the rotation signal of main motor 41 is associated with the load on photoconductors 3a to 3c. More specifically, the higher are the load on photoconductors 3a to 3c, the lower is the rotation signal for the control signal.

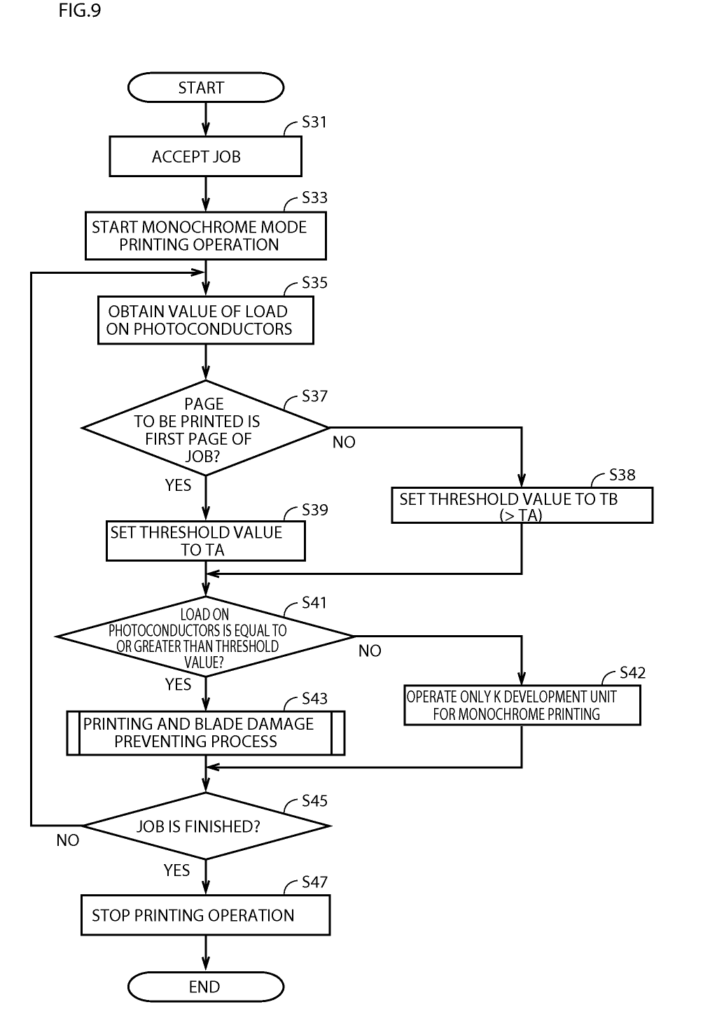

FIG. 9 is a flowchart B showing a process of preventing damage to blades 7a to 7c, which is executed by control unit 60 of image forming apparatus 1.

Referring to FIG. 9, when image forming apparatus 1 accepts a print job for a monochrome image (S31), control unit 60 starts a printing operation in the monochrome mode by allowing main motor 41 to rotatably drive photoconductors 3a to 3d (S33). Control unit 60 then obtains the load on photoconductors 3a to 3d (the load on main motor 41) during the printing operation (S35).

Control unit 60 then determines whether the page to be printed from now on is the first page of the job (S37). If it is determined that the page to be printed from now on is the first page of the job (YES in S37), control unit 60 sets the threshold value to a value TA (S39). If not (NO in S37), control unit 60 sets the value to a value TB larger than the value TA (S38).

After setting the threshold value, control unit 60 determines whether the obtained load on photoconductors 3a to 3d is equal to or greater than the threshold value (S41). If the load on photoconductors 3a to 3d is equal to or greater than the threshold value (YES in S41), it means that the load on photoconductors 3a to 3c increases and there is a likelihood of damage to blades 7a to 7c. In this case, a blade damage preventing process is performed together with printing (S43), as described later using FIG. 10. After executing printing of one page and a blade damage preventing process, control unit 60 proceeds to step S45.

If the obtained load on photoconductors 3a to 3d is smaller than the threshold value in step S41 (NO in S41), it means that the load on photoconductors 3a to 3c is low and there is no likelihood of damage to blades 7a to 7c. In this case, control unit 60 drives only K developing roller 4d (K development unit) to do printing of a monochrome image as usual, without performing a blade damage preventing process (S42). After executing printing of one page, control unit 60 proceeds to step S45.

In step S45, control unit 60 determines whether printing of the job is completely finished (S45). If printing of the job is not finished (NO in S45), the process returns to step S35 and proceeds to printing of the next page. If printing of the job is completely finished (YES in S45), control unit 60 stops the printing operation (S47). The process then ends.

FIG. 10 shows a subroutine of a printing and blade damage preventing process in FIG. 7 and FIG. 9 in details. In this printing and blade damage preventing process, the control of the damage preventing process differs depending on the obtained ratio of monochrome printing (S5 in FIG. 7) or value of load on the photoconductors (S35 in FIG. 9), and the damage preventing process is selected from one of the foregoing first to third methods of preventing damage.

Referring to FIG. 10, control unit 60 determines which of three ranges (“smaller than range A,” “range A,” and “larger than range A”) the obtained ratio of monochrome printing or load on photoconductors 3a to 3c falls in (S101). For example, if the threshold value of the printing ratio is 80% and range A of the printing ratio is between 85% and 95%, it is determined which of the following ranges the obtained ratio of monochrome printing falls in: not less than 80% to less than 85% (“smaller than range A”), not less than 85% and not greater than 95% (“range A”), and greater than 95% (“greater than range A”).

In step S101, if the obtained ratio of monochrome printing or load on photoconductors 3a to 3c is equal to or greater than the threshold value and smaller than range A (“smaller than range A” in S101), it means that the likelihood of damage to blades 7a to 7c is small. In this case, control unit 60 performs printing of a monochrome image by executing the second method of preventing blade damage, which has the smallest effect of blade protection but can reduce the toner consumption the most, among the forgoing first to third methods of preventing blade damage (S103). The process then returns. More specifically, control unit 60 drives K developing roller 4d (K development unit) to develop a K toner image on photoconductor 3d and rotatably drives Y, M, and C developing rollers 4a to 4c without developing toner images, causing fog toner to adhere to Y, M, and C photoconductors 3a to 3c.

In step S101, if the obtained ratio of monochrome printing or load on photoconductors 3a to 3c falls within range A (“range A” in S101), it means that the likelihood of damage to blades 7a to 7c is moderate. In this case, control unit 60 performs printing of a color image of Y and K by executing the third method of preventing blade damage, in which the blade protection effect and the toner consumption are second high, among the foregoing first to third methods of preventing blade damage (S105). The process then returns. More specifically, control unit 60 rotatably drives K developing roller 4d (K development unit) to develop a K toner image on photoconductor 3d, rotatably drives Y developing roller 4a (Y development unit) to develop a Y toner image on photoconductor 3a, and rotatably drives M and C developing rollers 4b and 4c without developing toner images, causing the reversely transferred Y toner to adhere to M and C photoconductors 3b and 3c.

In step S101, if the obtained ratio of monochrome printing or load on photoconductors 3a to 3c is greater than range A (“greater than range A” in S101), it means that the likelihood of damage to blades 7a to 7c is great. In this case, control unit 60 performs printing of a monochrome image by executing the first method of preventing blade damage, in which the toner consumption is highest but the blade protection effect is highest, among the foregoing first to third methods of preventing blade damage (S107). The process then returns. More specifically, control unit 60 drives Y, M, C, and K developing rollers 4a to 4d (Y, M, C, and K development units) to develop toner images on photoconductors 3a to 3d.

### (3) Flowchart C of Damage Preventing Process

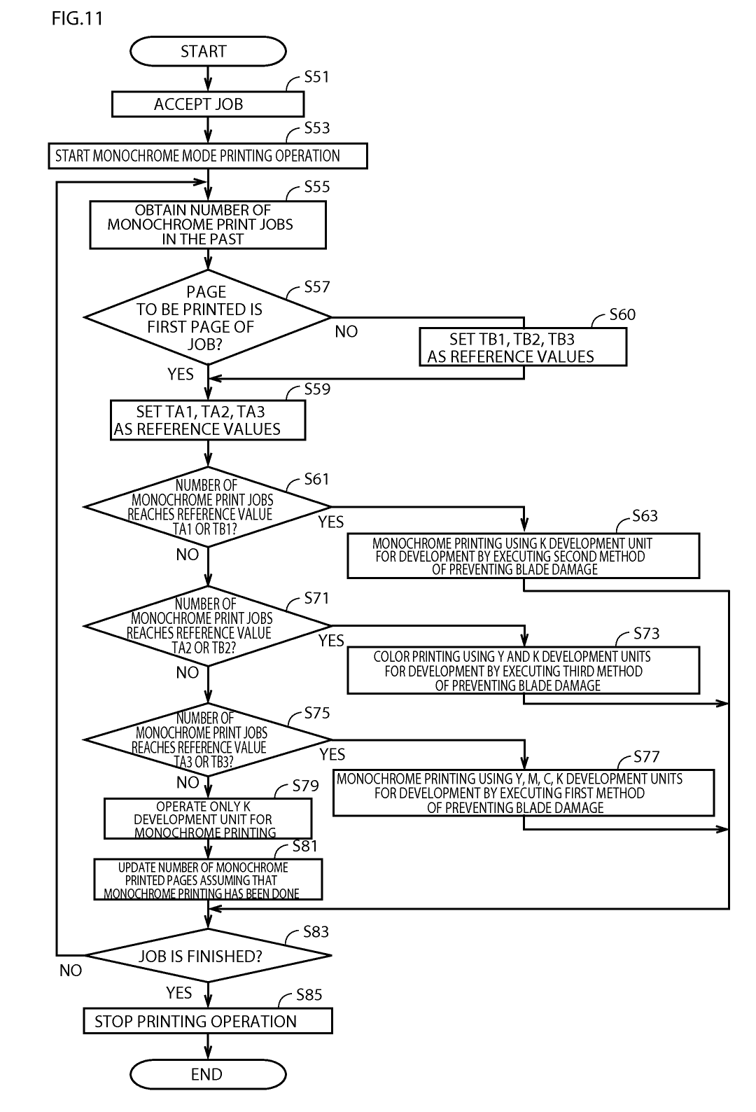

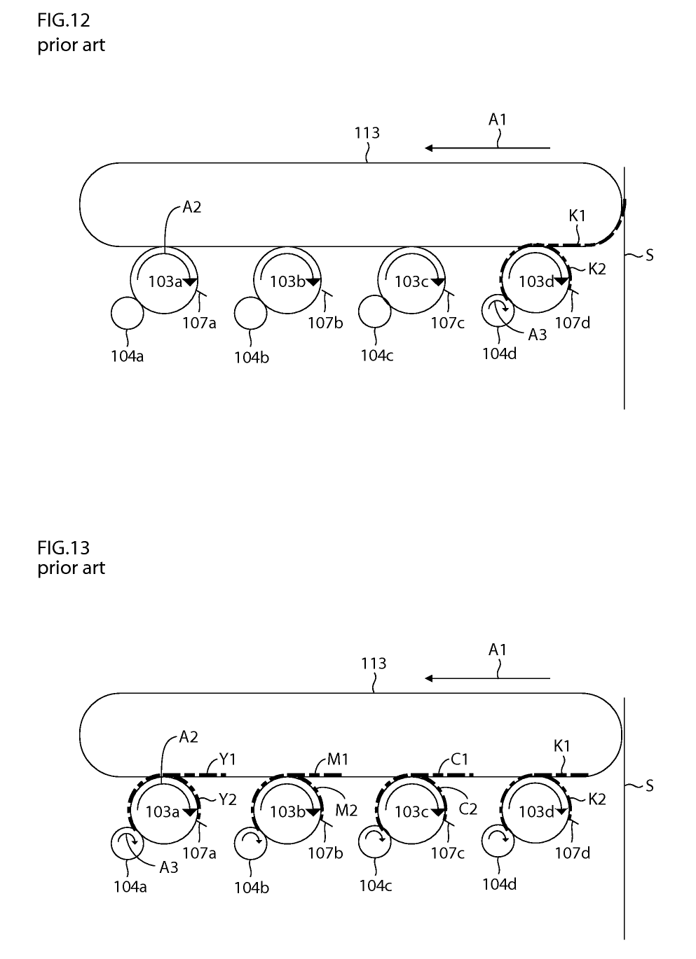

In a flowchart C of a damage preventing process, the likelihood of damage to blades 7a to 7c is determined based on whether the number of print jobs of monochrome images printed in image forming apparatus 1 agrees with a prescribed reference value, and if there is a likelihood of damage to blades 7a to 7c, a damage preventing process is executed. FIG. 11 is a flowchart C showing a process of preventing damage to blades 7a to 7c, which is executed by control unit 60 of image forming apparatus 1.

Referring to FIG. 11, when image forming apparatus 1 accepts a print job of a monochrome image (S51), control unit 60 starts a printing operation in the monochrome mode by allowing main motor 41 to rotatably drive photoconductors 3a to 3d (S53). Control unit 60 then obtains from storage unit 63 the number of print jobs of monochrome images printed in the past by image forming apparatus 1 (or the number of pages of monochrome images that have been printed so far) (S55).

Control unit 60 then determines whether the page to be printed from now on is the first page of the job (S57). If the page to be printed from now on is the first page of the job (YES in S57), control unit 60 sets three values, namely, TA1, TA2 (>TA1), and TA3 (>TA2) as the reference values (S59). If not (NO in S57), control unit 60 sets three values, namely, TB1, TB2 (>TB1), and TB3 (>TB2) as the reference values (S60). The value TB1 is greater than the value TA1, the value TB2 is greater than the value TA2, and the value TB3 is greater than the value TA3.

After setting the three reference values, control unit 60 determines whether the obtained number of print jobs of monochrome images reaches the value TA1, which is the smallest reference value (or the value TB1 where TB1, TB2, and TB3 are set as the reference values) (S61). If the obtained number of print jobs of monochrome images reaches the value TA1 (or the value TB1) (YES in S61), it means that monochrome images have been printed on as many sheets as a blade damage preventing process is required, although the likelihood of damage to blades 7a to 7c is small. In this case, control unit 60 executes the foregoing second method of preventing blade damage to perform printing of a monochrome image using K developing roller 4d (K development unit) for development (S63). The process then proceeds to step S83.

If the obtained number of print jobs of monochrome images is not the value TA1 (NO in S61), control unit 60 determines the obtained number of print jobs of monochrome images reaches the value TA2, which is the second smallest reference value (or the value TB2 where TB1, TB2, and TB3 are set as the reference values) (S71). If the obtained number of print jobs of monochrome images reaches the value TA2 (or the value TB2) (YES in S71), it means that the likelihood of damage to blades 7a to 7c is moderate and monochrome images have been printed on as many sheets as a blade damage preventing process is required. In this case, control unit 60 executes the foregoing third method of preventing blade damage to perform printing of a color image of K and Y using Y and K developing rollers 4a and 4d (Y and K development units) for development (S73). The process then proceeds to step S83.

If the obtained number of print jobs of monochrome images is not the value TA2 (NO in S71), control unit 60 determines whether the obtained number of print jobs of monochrome images reaches the value TA3, which is the greatest reference value (or the value TB3 where TB1, TB2, and TB3 are set as the reference values) (S75). If the obtained number of print jobs of monochrome images reaches the value TA3 (or the value TB3) (YES in S75), it means that the likelihood of damage to blades 7a to 7c is great and monochrome images have been printed on as many sheets as a blade damage preventing process is required. In this case, control unit 60 executes the foregoing first method of preventing blade damage to perform printing of a monochrome image in composite black using Y, M, C, and K developing rollers 4a to 4d (Y, M, C, and K development units) for development (S77). The process then proceeds to step S83.

If the obtained number of print jobs of monochrome images is not the value TA3 (NO in S75), it means that there is no likelihood of damage to blades 7a to 7c. In this case, control unit 60 does not perform a blade damage preventing process and performs printing of a monochrome image as usual by driving only K developing roller 4d (K development unit) (S79). After executing printing of one page, control unit 60 updates the number of printed pages of monochrome images that is stored in storage unit 63, assuming that printing of one page of a monochrome image has been executed (S81). The process then proceeds to step S83 described below.

In step S83, control unit 60 determines whether printing of the job is completely finished (S83). If printing of the job is not finished (NO in S83), the process returns to step S55 and proceeds to printing of the next page. If printing of the job is completely finished (YES in S83), control unit 60 stops the printing operation (S85). The process then ends. In this process, the process may proceed to step S63, for example, when the obtained number of print jobs reaches 100, may proceed to step S73 when it reaches 200, and may proceed to step S77 when it reaches 300.

### Effects of the Embodiment

In the present embodiment, Y, M, C, and K photoconductors 3a to 3d are driven in synchronization with each other when at least one of developing rollers 4a to 4d develops a toner image. When image forming apparatus 1 accepts a print job of a monochrome image, if there is a likelihood of damage to blades 7a to 7c, Y, M, and C developing rollers 4a to 4c adheres toner to the driven photoconductors 3a to 3c during execution of the print job.

In accordance with the present embodiment, if there is a likelihood of damage to blades 7a to 7c, toner is attached from Y, M, and C developing rollers 4a to 4c to photoconductors 3a to 3c, and the toner attached to photoconductors 3a to 3c is then removed by blades 7a to 7c, so that blades 7a to 7c can be periodically supplied with toner. Accordingly, toner, serving as lubricant, reduces friction between photoconductors 3a to 3c and blades 7a to 7c thereby reducing the load on blades 7a to 7c. As a result, damage to blades 7a to 7c can be prevented, and the durability of image forming apparatus 1 can be improved. In addition, toner is attached to blades 7a to 7c during execution of a print job (while a toner image for a monochrome image to be printed is being developed), thereby possibly eliminating the need for stopping printing for the job accepted in image forming apparatus 1 (eliminating the need for interruption). Reduction in productivity is thus avoided.

When the foregoing first method of preventing blade damage is used, a monochrome image is formed of composite black made of Y, M, and C. Therefore, a large amount of Y, M, C toners can be produced on photoconductors 3a to 3c to create a monochrome image, so that a large amount of toner can be attached to blades 7a to 7c. This increases the effect of preventing damage to blades 7a to 7c.

When the foregoing second method of preventing blade damage is used, development is not performed on Y, M, and C photoconductors 3a to 3c when toner is attached to blades 7a to 7c. This can reduce toner consumption of Y, M, and C.

When the foregoing third method of preventing blade damage is used, development is not performed on M and C photoconductors 3b and 3c when toner is attached to blades 7a to 7c. This can reduce toner consumption of M and C. A toner image is developed on Y photoconductor 3a, and Y toner adheres to M and C photoconductors 3b and 3c from the Y toner image transferred onto intermediate transfer belt 13, so that a relatively large amount of toner can be attached to M and C photoconductors 3b and 3c. This can increase the effect of preventing damage to blades 7a to 7c.

It is preferable that a blade damage preventing process is executed immediately after the start of a printing operation rather than during a printing operation because changing from the monochrome mode to the color mode wastes some time. This is because there is no concern about wasting time immediately after the start of a printing operation. Therefore, the reference values (TA, TA1, TA2, TA3) set in printing of the first page in a print job are set smaller than the reference values (TB, TB1, TB2, TB3) set in printing of the second and subsequent pages in the print job, so that the blade damage preventing process that brings Y, M, and C developing rollers 4a to 4c into operation is more likely to be performed immediately after the start of a printing operation.

### [Others]

In the processes in FIG. 7, FIG. 9, and FIG. 11, whether to perform a blade damage preventing process is determined using a threshold value (or reference value) for each page during execution of a job. However, this determination may not be made during execution of a job. More specifically, the determination may be made only at the start of a job, and depending on the determination result, a damage preventing process may not be performed at all or be continuously performed during execution of the job.

The number of jobs of monochrome printing obtained in step S55 in FIG. 11 may be the number of monochrome print jobs that are successively performed most recently.

In the foregoing embodiment, the likelihood of damage to the blades is determined based on the ratio of monochrome printing, the load on the main motor, or the number of pages of monochrome images that have been printed. However, in the present invention, any other information may be used to determine the likelihood of damage to the blades.

In the foregoing embodiment, one of the first to third methods of preventing blade damage is selected and executed, for example, based on the ratio of monochrome printing. However, the present invention may be configured such that only one or two of the first to third methods of preventing blade damage are executed and the other method(s) is not be executed.

In the foregoing embodiment, a damage preventing process is executed for each of the blades provided for the Y, M, and C photoconductors. However, in the present invention, a damage preventing process may be performed on a cleaning blade that removes toner adhering to at least one of the Y, M, and C developing rollers.

In the foregoing embodiment, a printer is shown as the image forming apparatus. However, the image forming apparatus may be an MFP or a copier, for example.

The processes in the foregoing embodiment may be performed by software or by a hardware circuit.

A program for executing the processes in the foregoing embodiment may be provided. A recording medium, such as a CD-ROM, flexible disk, hard disk, ROM, RAM, or memory card, encoded with the program may be provided to users. The program is executed by a computer such as a CPU. The program may be downloaded to the apparatus through a communication line such as the Internet.

The foregoing embodiment provides an image forming apparatus with improved durability, a method of controlling the image forming apparatus, and a recording medium storing a control program for the image forming apparatus.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image forming apparatus comprising:
an accepting unit for accepting a print job;
a yellow image carrying unit, a magenta image carrying unit, a cyan image carrying unit, and a black image carrying unit being capable of carrying toner images of yellow, magenta, cyan, and black, respectively;
a yellow development unit, a magenta development unit, a cyan development unit, and a black development unit being capable of developing toner images of yellow, magenta, cyan, and black, respectively, on said yellow image carrying unit, said magenta image carrying unit, said cyan image carrying unit, and said black image carrying unit, respectively;
a cleaning blade for removing toner adhering to at least one of said yellow image carrying unit, said magenta image carrying unit, and said cyan image carrying unit; and
a determination unit for determining a likelihood of damage to said cleaning blade, wherein
said yellow image carrying unit, said magenta image carrying unit, said cyan image carrying unit, and said black image carrying unit are driven in synchronization with each other when at least one of said yellow development unit, said magenta development unit, said cyan development unit, and said black development unit develops a toner image, and
when said accepting unit accepts a print job of a monochrome image and if said determination unit determines that there is a likelihood of damage to said cleaning blade, at least one of said yellow development unit, said magenta development unit, and said cyan development unit adheres toner to at least one of driven said yellow image carrying unit, said magenta image carrying unit, and said cyan image carrying unit during execution of said print job.

2. The image forming apparatus according to claim 1, wherein when said accepting unit accepts a print job of a monochrome image and if said determination unit determines that there is a likelihood of damage to said cleaning blade, said yellow development unit, said magenta development unit, and said cyan development unit each develop a toner image so as to create the monochrome image of said print job, at least using respective toner images carried on said yellow image carrying unit, said magenta image carrying unit, and said cyan image carrying unit.

3. The image forming apparatus according to claim 2, wherein when said accepting unit accepts a print job of a monochrome image and if said determination unit determines that there is a likelihood of damage to said cleaning blade, said black development unit develops a loner image so as to create the monochrome image of said print job, additionally using a toner image carried on said black image carrying unit.

4. The image forming apparatus according to claim 3, wherein
said yellow development unit, said magenta development unit, and said cyan development unit each develop a toner image such that a first black area is formed in the monochrome image of said print job, using respective toner images carried on said yellow image carrying unit, said magenta image carrying unit, and said cyan image carrying unit, and
said black development unit develops a toner image such that a second black area is formed to surround said first black area in the monochrome image of said print job, using a toner image carried on said black image carrying unit.

5. The image forming apparatus according to claim 1, wherein when said accepting unit accepts a print job of a monochrome image and if said determination unit determines that there is a likelihood of damage to said cleaning blade, said yellow development unit, said magenta development unit, and said cyan development unit adhere toner to driven said yellow image carrying unit, said magenta image carrying unit, and said cyan image carrying unit, respectively, without developing a toner image, during execution of said print job.

6. The image forming apparatus according to claim 1, further comprising a transferred unit capable of receiving transfer of a toner image from each of said yellow image carrying unit, said magenta image carrying unit, said cyan image carrying unit, and said black image carrying unit, wherein
when said accepting unit accepts a print job of a monochrome image and if said determination unit determines that there is a likelihood of damage to said cleaning blade, said yellow development unit develops a toner image on driven said yellow image carrying unit during execution of said print job, and
said transferred unit adheres yellow toner included in the toner image transferred from said yellow image carrying unit, to each of driven said magenta image carrying unit and said cyan image carrying unit.

7. The image forming apparatus according to claim 6, wherein when said accepting unit accepts a print job of a monochrome image and if said determination unit determines that there is a likelihood of damage to said cleaning blade, said yellow development unit develops a toner image such that a yellow dotted area is added to the image of said print job.

8. The image forming apparatus according to claim 1, wherein
said determination unit includes a proportion obtaining unit for obtaining a proportion of a number of pages of monochrome images to a total number of pages of color images and monochrome images that are printed in the image forming apparatus, and
said determination unit determines that there is a likelihood of damage to said cleaning blade if the proportion obtained by said proportion obtaining unit is equal to or greater than a reference value for the proportion.

9. The image forming apparatus according to claim 8, further comprising a reference value setting unit for setting a reference value to be used by said determination unit to a first value, in printing of a first page for a print job accepted by said accepting unit, and for setting a reference value to be used by said determination unit to a second value greater than said first value, in printing of second and subsequent pages for a print job accepted by said accepting unit.

10. The image forming apparatus according to claim 1, wherein
said determination unit includes a load obtaining unit for obtaining a value concerning load on each of said yellow image carrying unit, said magenta image carrying unit, said cyan image carrying unit, and said black image carrying unit, and
said determination unit determines that there is a likelihood of damage to said cleaning blade if the value concerning load that is obtained by said load obtaining unit is equal to or greater than a reference value for the load.

11. The image forming apparatus according to claim 1, wherein
said determination unit includes a job count obtaining unit for obtaining a number of print jobs of monochrome images printed in the image forming apparatus, and
said determination unit determines a likelihood of damage to said cleaning blade based on whether the number of print jobs obtained by said job count obtaining unit agrees with a reference value for the number of print jobs.

12. A method of controlling an image forming apparatus, said image forming apparatus including
a yellow image carrying unit, a magenta image carrying unit, a cyan image carrying unit, and a black image carrying unit being capable of carrying toner images of yellow, magenta, cyan, and black, respectively,
a yellow development unit, a magenta development unit, a cyan development unit, and a black development unit being capable of developing toner images of yellow, magenta, cyan, and black, respectively, on said yellow image carrying unit, said magenta image carrying unit, said cyan image carrying unit, and said black image carrying unit, respectively, and
a cleaning blade for removing toner adhering to at least one of said yellow image carrying unit, said magenta image carrying unit, and said cyan image carrying unit,
said yellow image carrying unit, said magenta image carrying unit, said cyan image carrying unit, and said black image carrying unit being driven in synchronization with each other when at least one of said yellow development unit, said magenta development unit, said cyan development unit, and said black development unit develops a toner image, said method comprising the steps of:
accepting a print job;
determining a likelihood of damage to said cleaning blade; and
adhering toner to at least one of driven said yellow image carrying unit, said magenta image carrying unit, and said cyan image carrying unit by at least one of said yellow development unit, said magenta development unit, and said cyan development unit during execution of said job, when a print job of a monochrome image is accepted in said step of accepting and if it is determined that there is a likelihood of damage to said cleaning blade in said step of determining.

13. A non-transitory computer-readable recording medium storing a control program for an image forming apparatus, said image forming apparatus including
a yellow image carrying unit, a magenta image carrying unit, a cyan image carrying unit, and a black image carrying unit being capable of carrying toner images of yellow, magenta, cyan, and black, respectively,
a yellow development unit, a magenta development unit, a cyan development unit, and a black development unit being capable of developing toner images of yellow, magenta, cyan, and black, respectively, on said yellow image carrying unit, said magenta image carrying unit, said cyan image carrying unit, and said black image carrying unit, respectively, and
a cleaning blade for removing toner adhering to at least one of said yellow image carrying unit, said magenta image carrying unit, and said cyan image carrying unit,
said yellow image carrying unit, said magenta image carrying unit, said cyan image carrying unit, and said black image carrying unit being driven in synchronization with each other when at least one of said yellow development unit, said magenta development unit, said cyan development unit, and said black development unit develops a toner image,
said control program causing a computer to execute processing comprising the steps of:
accepting a print job;
determining a likelihood of damage to said cleaning blade; and
adhering toner to at least one of driven said yellow image carrying unit, said magenta image carrying unit, and said cyan image carrying unit by at least one of said yellow development unit, said magenta development unit, and said cyan development unit during execution of said job, when a print job of a monochrome image is accepted in said step of accepting and if it is determined that there is a likelihood of damage to said cleaning blade in said step of determining.

14. The recording medium according to claim 13, wherein when a print job of a monochrome image is accepted in said step of accepting and if it is determined that there is a likelihood of damage to said cleaning blade in said step of determining, said yellow development unit, said magenta development unit, and said cyan development unit each develop a toner image so as to create the monochrome image of said print job, at least using respective toner images carried on said yellow image carrying unit, said magenta image carrying unit, and said cyan image carrying unit, in said step of adhering.

15. The recording medium according to claim 14, wherein when a print job of a monochrome image is accepted in said step of accepting and if it is determined that there is a likelihood of damage to said cleaning blade in said step of determining, said black development unit develops a toner image so as to create the monochrome image of said print job, additionally using a toner image carried on said black image carrying unit, in said step of adhering.

16. The recording medium according to claim 15, wherein
said yellow development unit, said magenta development unit, and said cyan development unit each develop a toner image such that a first black area is formed in the monochrome image of said print job, using respective toner images carried on said yellow image carrying unit, said magenta image carrying unit, and said cyan image carrying unit, in said step of adhering, and
said black development unit develops a toner image such that a second black area is formed to surround said first black area in the monochrome image of said print job, using a toner image carried on said black image carrying unit, in said step of adhering.

17. The recording medium according to claim 13, wherein when a print job of a monochrome image is accepted in said step of accepting and if it is determined that there is a likelihood of damage to said cleaning blade in said step of determining, said yellow development unit, said magenta development unit, and said cyan development unit adhere toner to driven said yellow image carrying unit, said magenta image carrying unit, and said cyan image carrying unit, respectively, without developing a toner image, during execution of said print job, in said step of adhering.

18. The recording medium according to claim 13, wherein
said image forming apparatus further includes a transferred unit capable of receiving transfer of a toner image from each of said yellow image carrying unit, said magenta image carrying unit, said cyan image carrying unit, and said black image carrying unit,
when a print job of a monochrome image is accepted in said step of accepting and if it is determined that there is a likelihood of damage to said cleaning blade in said step of determining, said yellow development unit develops a toner image on driven said yellow image carrying unit during execution of said print job, and said transferred unit adheres yellow toner included in the toner image transferred from said yellow image carrying unit, to each of driven said magenta image carrying unit and said cyan image carrying unit, in said step of adhering.

19. The recording medium according to claim 18, wherein when a print job of a monochrome image is accepted in said step of accepting and if it is determined that there is a likelihood of damage to said cleaning blade in said step of determining, said yellow development unit develops a toner image such that a yellow dotted area is added to the image of said print job, in said step of adhering.

20. The recording medium according to claim 13, wherein
said step of determining includes the step of obtaining a proportion of a number of pages of monochrome images to a total number of pages of color images and monochrome images that are printed in the image forming apparatus, and
if the proportion obtained in said step of obtaining a proportion is equal to or greater than a reference value for the proportion, it is determined that there is a likelihood of damage to said cleaning blade in said step of determining.

21. The recording medium according to claim 20, wherein said control program further comprises the step of setting a reference value to be used in said step of determining to a first value, in printing of a first page for a print job accepted in said of accepting, and setting a reference value to be used in said step of determining to a second value greater than said first value, in printing of second and subsequent pages for a print job accepted in said step of accepting.

22. The recording medium according to claim 13, wherein
said step of determining includes the step of obtaining a value concerning load on each of said yellow image carrying unit, said magenta image carrying unit, said cyan image carrying unit, and said black image carrying unit, and
if the value concerning load that is obtained in said step of obtaining a value concerning load is equal to or greater than a reference value for the load, it is determined that there is a likelihood of damage to said cleaning blade.

23. The recording medium according to claim 13, wherein
said step of determining includes the step of obtaining a number of print jobs of monochrome images printed in the image forming apparatus, and
a likelihood of damage to said cleaning blade is determined based on whether the number of print jobs obtained in said step of obtaining a number of print jobs agrees with a reference value for the number of print jobs.
